(19) United States
(12) Patent Application Publication
(10) Pub. No.: US 2023/0274294 A1
(43) Pub. Date: Aug. 31, 2023

(54) INFORMATION ANALYSIS METHOD

(71) Applicant: NEC Corporation, Minato-ku, Tokyo (JP)

(72) Inventors: Katsuya HIROSE, Tokyo (JP); Takayuki YAMASHITA, Tokyo (JP); Hiroaki ARIE, Tokyo (JP); Jun KAZAMA, Tokyo (JP); Saori TSUNEKAWA, Tokyo (JP)

(73) Assignee: NEC Corporation, Minato-ku, Tokyo (JP)

(21) Appl. No.: 18/014,693

(22) PCT Filed: Jul. 9, 2020
(86) PCT No.: PCT/JP2020/026924

§ 371 Date: Jan. 5, 2023

(51) Int. Cl. G06Q 30/0201

(52) U.S. Cl. CPC G06Q 30/0201

(57) ABSTRACT

An information analysis apparatus according to the present invention includes an acquiring unit configured to acquire action information representing an action of a customer, and a determining unit configured to determine, for each of a plurality of kinds of involvement items set for a predetermined brand, a degree of involvement in the brand of the customer based on the action information.

### TECHNICAL FIELD

The present invention relates to an information analysis method, an information analysis apparatus and a program for analyzing information for marketing activities.

### BACKGROUND ART

One of marketing activities by a company is to measure loyalty such as knowledge and fidelity of a customer to a brand provided by the company. For example, a method for measuring loyalty includes RFM analysis using customer's purchasing action and net promoter score using customer's questionnaire responses. Patent Document 1 also describes a method for measuring loyalty using questionnaire responses.

### Patent Document 1: Japanese Patent Publication No. 6656546

However, there is a case where it is difficult to measure loyalty from multiple perspectives by the abovementioned conventional method. Therefore, there is a case where it is difficult to increase the quality of marketing activities.

### SUMMARY

Accordingly, an object of the present invention is to provide an information analysis method, an information analysis apparatus and a program that enable further increase of marketing activities, which is the abovementioned task.

An information analysis method as an aspect of the present invention includes: acquiring action information representing an action of a customer; and determining, for each of a plurality of kinds of involvement items set for a predetermined brand, a degree of involvement in the brand of the customer based on the action information.

Further, an information analysis apparatus as an aspect of the present invention includes: an acquiring unit configured to acquire action information representing an action of a customer; and a determining unit configured to determine, for each of a plurality of kinds of involvement items set for a predetermined brand, a degree of involvement in the brand of the customer based on the action information.

Further, a computer program as an aspect of the present invention includes instructions to cause an information processing apparatus to implement: an acquiring unit configured to acquire action information representing an action of a customer; and a determining unit configured to determine, for each of a plurality of kinds of involvement items set for a predetermined brand, a degree of involvement in the brand of the customer based on the action information.

With the configurations as described above, the present invention enables further increase of marketing activities.

### BRIEF DESCRIPTION OF DRAWINGS

FIG. 1 is a block diagram showing a configuration of an information processing apparatus in a first example embodiment of the present invention;

FIG. 2 is a figure showing a way of processing by the information processing apparatus disclosed in FIG. 1 in the first example embodiment of the present invention;

FIG. 3 is a figure showing a way of processing by the information processing apparatus disclosed in FIG. 1 in the first example embodiment of the present invention;

FIG. 4 is a figure showing a way of processing by the information processing apparatus disclosed in FIG. 1 in the first example embodiment of the present invention;

FIG. 5 is a figure showing a way of processing by the information processing apparatus disclosed in FIG. 1 in the first example embodiment of the present invention;

FIG. 6 is a flowchart showing an operation of the information processing apparatus disclosed in FIG. 1 in the first example embodiment of the present invention;

FIG. 7 is a figure showing a way of processing by the information processing apparatus disclosed in FIG. 1 in a second example embodiment of the present invention;

FIG. 8 is a figure showing a way of processing by the information processing apparatus disclosed in FIG. 1 in the second example embodiment of the present invention;

FIG. 9 is a figure showing a way of processing by the information processing apparatus disclosed in FIG. 1 in the second example embodiment of the present invention;

FIG. 10 is a figure showing a way of processing by the information processing apparatus disclosed in FIG. 1 in the second example embodiment of the present invention;

FIG. 11 is a figure showing a way of processing by the information processing apparatus disclosed in FIG. 1 in the second example embodiment of the present invention;

FIG. 12 is a figure showing a way of processing by the information processing apparatus disclosed in FIG. 1 in the second example embodiment of the present invention;

FIG. 13 is a figure showing a way of processing by the information processing apparatus disclosed in FIG. 1 in the second example embodiment of the present invention;

FIG. 14 is a flowchart showing an operation of the information processing apparatus disclosed in FIG. 1 in the second example embodiment of the present invention;

FIG. 15 is a flowchart showing an operation of the information processing apparatus disclosed in FIG. 1 in the second example embodiment of the present invention;

FIG. 16 is a flowchart showing an operation of the information processing apparatus disclosed in FIG. 1 in the second example embodiment of the present invention;

FIG. 17 is a block diagram showing a hardware configuration of an information analysis apparatus in a third example embodiment of the present invention;

FIG. 18 is a block diagram showing a configuration of the information analysis apparatus in the third example embodiment of the present invention; and

FIG. 19 is a flowchart showing an operation of the information analysis apparatus in the third example embodiment of the present invention.

### EXAMPLE EMBODIMENTS

### First Example Embodiment

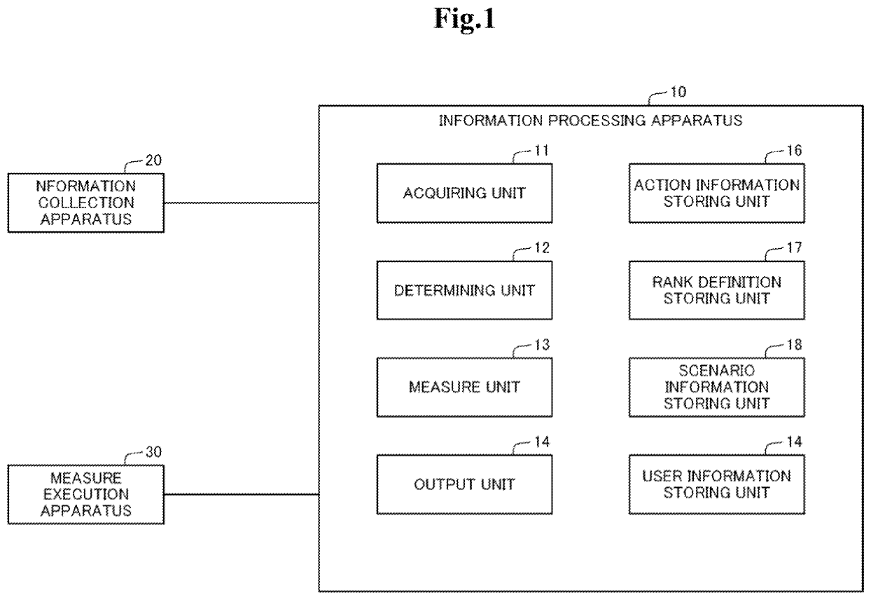

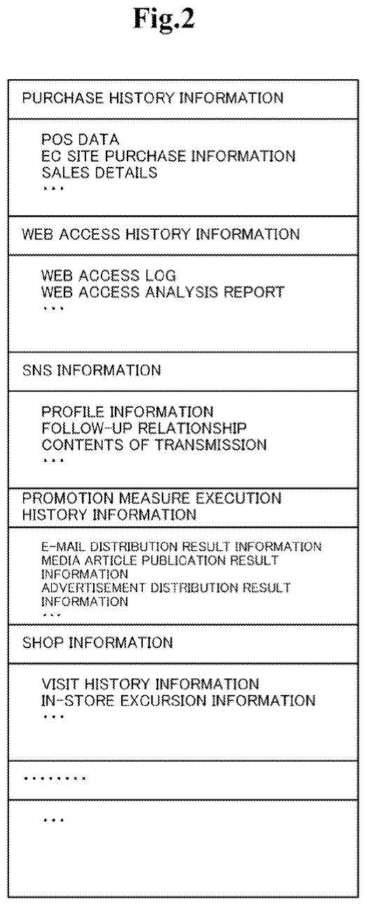

A first example embodiment of the present invention will be described with reference to FIGS. 1 to 6. FIG. 1 is a figure for describing a configuration of an information processing apparatus, and FIGS. 2 to 6 are figures for describing a processing operation of the information processing apparatus.

An information processing apparatus 10 in this example embodiment is for analyzing loyalty of a customer such as attachment and fidelity to a “brand” of products and services provided by a company, and for assisting subsequent marketing to the customer. In this example embodiment, a case where the information processing apparatus 10 functions as an information analysis apparatus that analyzes the loyalty of a customer will be described. In a second embodiment, a case where the information processing apparatus 10 functions as an information analysis apparatus that assists marketing will be described. A “brnd” in the present disclosure includes information indicating a company that provides services/products (company name, and the like) and comprehensive names related to services/products.

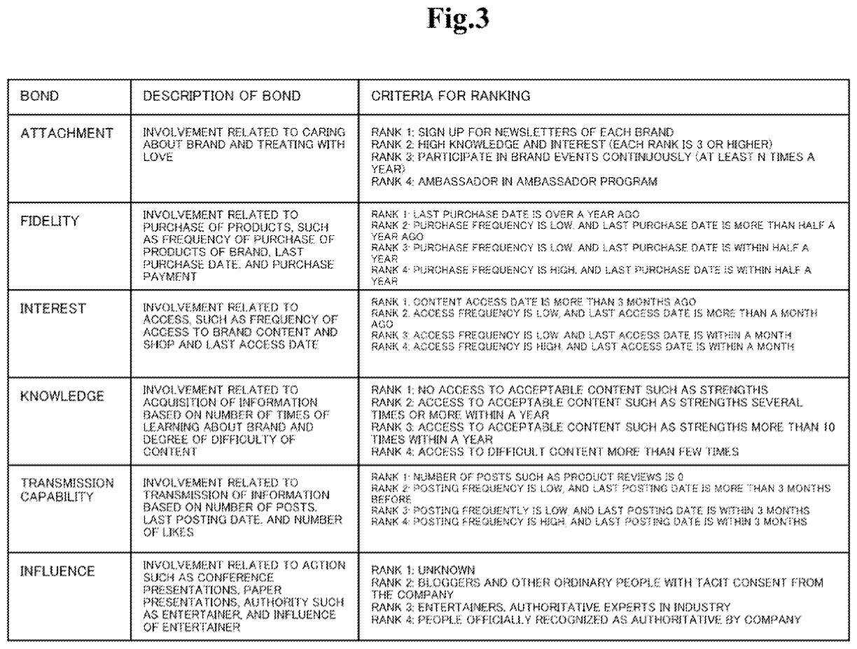

The loyalty of a customer analyzed in this example embodiment is the “degree of involvement” of a customer in a brand, and is also represented by a word of “bond”. In this example embodiment, the degree of involvement of a customer in a brand is determined for each of a plurality of involvement items set in advance. In this example embodiment, as shown in the “bond” column in FIG. 3, six types including “attachment”, “fidelity”, “interest”, “knowledge”, “communication capability”, and “influence are set as the involvement items.

“Attachment” represents involvement related to treating with love, such as how much the customer cares about the brand and how much the customer devotes to the brand as a fan.

“Fidelity” represents involvement related to purchase of a product, such as the frequency of purchase of a product of the brand, the last purchase date, and the purchase payment.

“Interest” represents involvement related to access to the brand, such as the frequency of access to the content and shop of the brand and the last access date.

“Knowledge” represents involvement related to acquisition of information, such as the number of times the customer learned about the brand and the degree of difficulty of the content.

“Communication capability” represents involvement related to transmission of information, such as the number of posts, the last posting date, and the number of likes.

“Influence” represents involvement related to an action such as conference presentations, paper presentations, an authority such as an entertainer, and an influence that the person has.

However, the number of involvement items and the contents thereof described above are examples, and the number of involvement items and the contents thereof are not limited to those described above.

The information processing apparatus 10 is configured by one or a plurality of information processing apparatuses including an arithmetic logic unit and a memory unit. Then, as shown in FIG. 1, the information processing apparatus 10 includes an acquiring unit 11, a determining unit 12, a measure unit 13, and an output unit 14. The functions of the acquiring unit 11, the determining unit 12, the measure unit 13, and the output unit 14 can be implemented by execution of a program for implementing the respective functions stored in the memory unit by the arithmetic logic unit. The information processing apparatus 10 also includes an action information storing unit 16, a rank definition storing unit 17, a scenario information storing unit 18, and a user information storing unit 19. In the information processing apparatus 10, the action information storing unit 16, the rank definition storing unit 17, the scenario information storing unit 18, and the user information storing unit 19 are configured by the memory unit. The details of the respective components will be described below together with an operation of the information processing apparatus 10.

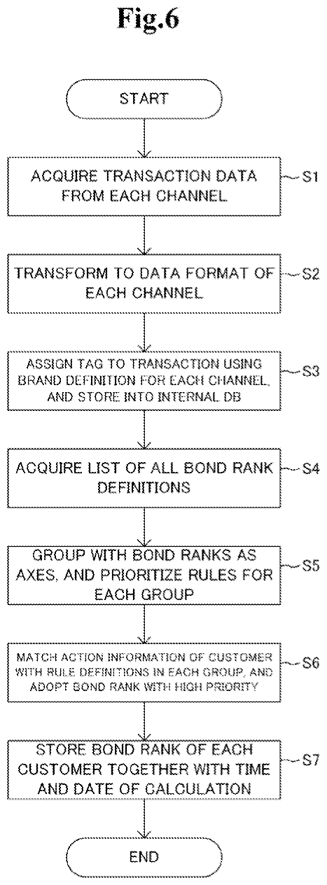

The acquiring unit 11 (acquiring unit) acquires action information representing a customer's action to a brand, and stores the action information into the action information storing unit 16. For example, the action information is classified into a plurality of information channels such as purchase history, web access history, e-mail opening history, event participation history, and SNS with respect to products and services of the brand by a customer, and is formed by transaction data related to the respective channels. Therefore, the acquiring unit 11 collects the action information formed by the transaction data described above from servers that provide services such as POS, EC sites, SNS and e-mail distribution, an information collection apparatus that collects a variety of information, a measure execution apparatus 30 that executes a measure such as e-mail distribution, and the like (step S1 in FIG. 6).

As an example, as shown in FIG. 2, the action information includes purchase history information including POS data, EC site purchase information and sales details, web access history information including a web access log and a web access analysis report, SNS information including profile information, a follow-up relationship and transmission contents, promotion measure execution history information including e-mail distribution result information, media article publication result information and advertisement distribution result information, shop information including visit history information and in-store excursion information, and the like. The action information also includes information that identifies a brand such as a brand name targeted for an action by a customer. However, in a case where there is one brand targeted for information analysis, the action information does not need to include information that identifies the brand.

Then, when storing the acquired transaction data as the action information of the customer into the action information storing unit 16, the acquiring unit 11 assigns a “brand tag” for identifying what brand the transaction is for and a “content type tag” representing what action the transaction is for to the transaction data, selects only information necessary for information analysis, puts together as data for each channel, and stores the data. For example, the acquiring unit 11 transforms the transaction data in the format of (who), (when), (where), (how many) and (what brand), and puts together as one data for each type of (what). Consequently, the acquiring unit 11 acquires the transaction data as the action information of the customer with respect to a certain brand.

Specifically, the acquiring unit 11 first refers to channel definition information set in advance, and transforms in accordance with a format of each channel (step S2 in FIG. 6). For example, the acquiring unit 11 transforms transaction data acquired from the POS and transaction data acquired from the purchase history information of the EC site in the same form of (who), (when) and (how much), and stores into the purchase channel history information. Then, the acquiring unit 11 generates tagged information in the above manner for the transformed information, and stores as customer's action information with a brand tag and a content type tag assigned on a channel-by-channel basis (step S3 in FIG. 6). For example, in the case of the web access history information, information to which a brand tag and a content tag are assigned for each URL is tagged information, and the acquiring unit 12 adds (brand tag) and (content type tag) to the transaction data generated from the web access history information and stores.

The determining unit 12 (determining unit) determines, for each customer, a rank representing the degree of involvement in a brand for each involvement item (bond) based on the contents of customer's action information.

Specifically, the determining unit 12 first acquires bond rank rule definition information stored in advance in the rank definition storing unit 17 (step S4 in FIG. 6). An example of the bond rank rule definition information will be described with reference to FIG. 3. The bond rank rule definition information is set for each brand, and a criterion for the contents of the action information of a customer to be ranked is set for each bond. In this example embodiment, a larger number of a rank in each bond represents a higher degree of involvement of a customer in the

An example of the contents of action information for which a rank in each bond is determined is as follows. A rank in the bond “attachment” is determined by the presence or absence of newsletter registration, ranks in the other bonds, participation in events, a level in an ambassador program, and the like. A rank in the bond “fidelity” is determined by the date of purchase and the frequency of purchase. A rank in the bond “interest” is determined by the date of last access to the content and the frequency of access to the content. A rank in the bond “knowledge” is determined by the number of times of accessing specific content and the difficulty of accessed content. A rank in the bond “communication capability” is determined by the frequency of posts such as product reviews and the date of the last post. A rank in the bond “influence” is determined by the name recognition, status, and authority of the customer.

Thus, the criteria for determining the ranks in the respective bonds are set based on the degree of customer's participation action to executed measures such as brand-related events, newsletter distribution, sales and information provision, the degree of customer's action related to purchase of products, the degree of customer's action related to reception or transmission of information, and the like. Meanwhile, the criteria for determining the ranks in the respective bonds are not limited to the above.

Then, the determining unit 12 groups the bond rank rule definition information described above by the axes of brand and bond rank, and prioritize bond rank rule definitions within each group (step S5 in FIG. 6). For example, the determining unit 12 puts bond rank rules related to “knowledge” of “brand A” together as one group, and gives higher priority to the rule with rank 2 than the rule with rank 1.

Subsequently, the determining unit 12 retrieves the customer's action information, matches the customer's action information with the bond rank rule definition information in each group, and adopts a rule with high priority (step S6 in FIG. 6). Thus, the determining unit 12 determines a rank in each bond of a customer in each group. When determining the rank, the determining unit 12 matches the bond rank rule definition information with the action information by using the brand tag and the content type tag described above. That is to say, the determining unit 12 matches information of each tag assigned to action information (transaction data) with information in the bond rank rule definition information corresponding to the tag, and determines a rank for the action information.

For example, in the group of “brand A” and “knowledge”, the determining unit 12 matches a “rank 1” and a “rank 2” with the action information of a customer “Nichiden Taro” and, in a case where both the “rank 1” and the “rank 2” match the action information, adopts the “rank 2” having a higher priority. As a result, the determining unit 12 can determine that a rank in the bond “knowledge” of the “brand A” of the customer “Nichiden Taro” is the “rank 2.

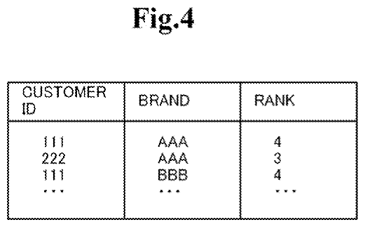

Likewise, the determining unit 12 determines ranks in all the bonds of the customer “Nichiden Taro”, respectively, and also determines ranks in all the bonds of all the customers. Then, the determining unit 12 stores a rank in each bond of each customer together with the time and date of calculation into the user information storing unit 19 as bond rank information (step S7 in FIG. 6). For example, as shown in FIG. 4, the determining unit 12 stores the respective brand ranks of customers in one bond in the tabular format. The format of the data to store is not limited to the tabular format.

Although an example in which the determining unit 12 sets the priorities of rules has been described herein, the priorities may be set manually. In this case, the determining unit 12 determines the rank of a customer based on the action information of the customer and the preset priorities.

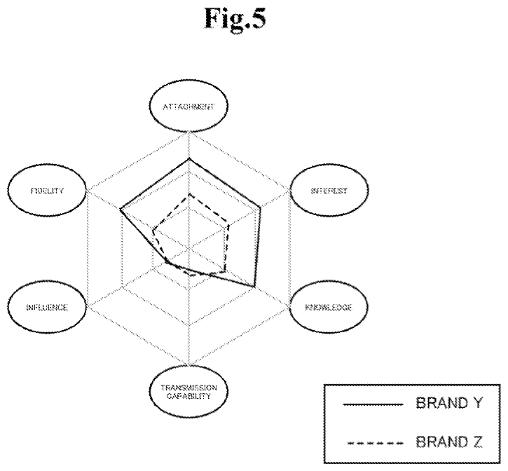

The output unit 14 outputs the determined customer's bond rank information. For example, the output unit 14 may output a table as shown in FIG. 4, or may display a rank in each bond determined for each brand with respect to a specific customer on a graph with the six bonds set as axes as shown in FIG. 5. By displaying and outputting in this manner, it is possible to visualize the bond to a brand of a customer from various perspectives.

Thus, according to the information processing apparatus 10 described above, it is possible to measure the degrees of a plurality of indexes such as knowledge and fidelity with respect to a brand, and to measure the loyalty to the brand of a customer from various perspectives. As a result, the company can analyze and evaluate the customer's loyalty in detail, and can further increase marketing activities by taking measures such as a measure appropriate for the analysis result.

### Second Example Embodiment

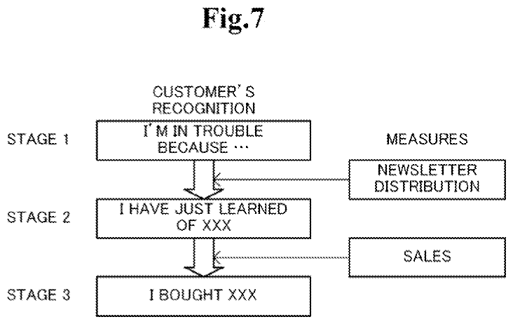

Next, a second example embodiment of the present invention will be described with reference to FIGS. 7 to 16. FIGS. 7 to 16 are figures for describing a processing operation of the information processing apparatus 10 in the second example embodiment.

The information processing apparatus 10 in this example embodiment is the same apparatus as the information processing apparatus 10 shown in FIG. 1 described in the first example embodiment. In this example embodiment, a case where the information processing apparatus 10 functions as an information analysis apparatus that assists marketing will be described.

In particular, in this example embodiment, the information processing apparatus 10 executes measures related to marketing such as distribution of newsletters and sales calls to customers, examines the effects to evaluate the effectiveness of the measures, and provides marketing assistance.

In the information processing apparatus 10, action information of a customer is stored in the action information storing unit 16 as described above. Then, the determining unit 12 of the information processing apparatus 10 determines a “stage” that represents the degree of recognition to a brand of the customer from the action information of the customer. A stage refers to a degree representing how a customer recognizes a brand, and stages can include, for example, not knowing at all, being interested, and considering purchase. At the time, “stage rule definition information” to be a criterion for determining the stage is included in “scenario information” stored in the scenario information storing unit 18 of the information processing apparatus 10.

The scenario information will be described with reference to FIGS. 7 to 10. As shown in FIG. 7, the scenario information includes a series of stages representing the degrees of recognition to a brand of a customer, and marketing measures applied to the customer in the respective stages. For example, in the scenario information shown in FIG. 7, in a case where “XXX” is a product of a brand, a series of stages representing customer's recognition such as “Stage 1: I am in trouble because”, “Stage 2: I have just learned of XXX”, “Stage 3: I have bought XXX” are set, and measures such as “newsletter distribution” for a customer in the stage 1 and “sales” for a customer in the stage 2 are set.

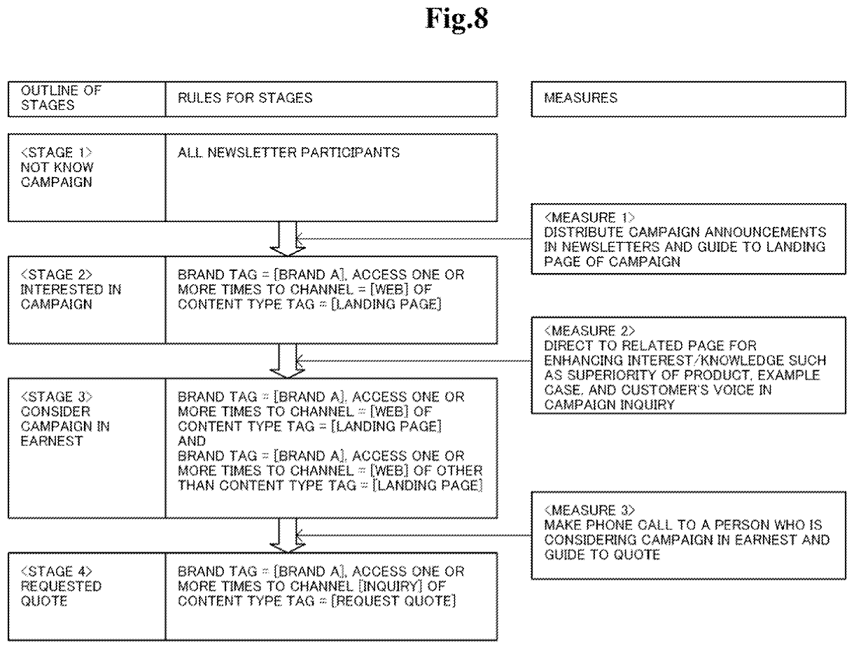

Further, a specific example of the scenario information will be described with reference to FIGS. 8 to 10.

In the example of FIG. 8, first, the degrees of recognition of a customer to a “brand A” are set to stages 1 to 4. In the scenario information, the contents of action information as shown below are set for the respective stages as stage rule definition information representing the criteria for determining the stage of a customer. As the criterion for action information of a customer falling into “Stage 1: Not know Brand A”, “Newsletter reader” is set. As the criterion for action information of a customer falling into “Stage 2: Interested in campaign”, brand tag=[brand A] and access one or more times to channel=[Web] of content type tag=[landing page] is set. Moreover, as the criterion for action information of a customer falling into “Stage 3: Consider campaign in earnest”, brand tag=[brand A] and access one or more times to channel=[Web] of content type tag=[landing page], and brand tag=[brand A] and access one or more times to channel=[Web] of other than content type tag=[landing page] are set. Furthermore, as the criterion for a customer falling into “Stage 4: Requested a quote”, brand tag=[brand A] and access one or more times to channel [Web] of content type tag=[landing page] is set.

Then, in the scenario information shown in FIG. 8, the following three measures are set as measures. For the customer in Stage 1, “Measure 1: Distribute campaign announcements in newsletters and guide to the landing page of the campaign” is set. For the customer in Stage 2, “Measure 2: direct to a related page for enhancing interest/knowledge such as superiority of product, example case, and customer's voice in campaign inquiry” is set. For the customer in “Stage 3”, “Measure 3: Make a sales call to a person who is seriously considering the campaign and guide to a quote” is set.

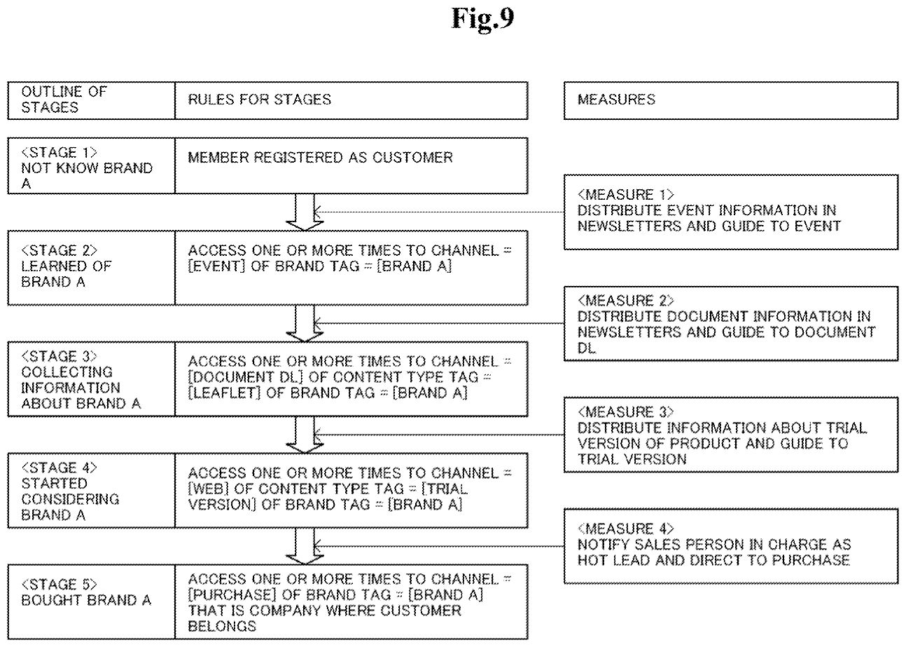

Further, in the example of FIG. 9, in the scenario information, the contents of action information as described below are set for the respective stages as stage rule definition information representing the criteria for determining the stage of a customer. “Member registered as customer” is set as the criterion for action information of a customer falling into “Stage 1: Not know Brand A”. As the criterion for action information of a customer falling into “Stage 2: Learned of Brand A”, access one or more times to channel=[event] of brand tag=[brand A] is set. Moreover, as the criterion for action information of a customer falling into “Stage 3: Collecting information about brand A”, access one or more times to channel=[document DL] of content type tag=[leaflet] of brand tag=[brand A] is set. Moreover, as the criterion for action information of a customer falling into “Stage 4: Started considering brand A”, access one or more times to channel=[Web] of content type tag=[trial version] of brand tag=[brand A] is set. Furthermore, as the criterion for action information of a customer falling into “Stage 5: Bought brand A”, access one or more times to channel=[purchase] of brand tag=[brand A] that is a company where the customer belongs is set.

In the scenario information shown in FIG. 9, the following four measures are set as measures. For the customer in Stage 1, “Measure 1: Distribute event information in newsletters and guide to the event” is set. For the customer in Stage 2, “Measure 2: Distribute document information in newsletters and guide to document DL” is set. Moreover, for the customer in Stage 3, “Measure 3: Distribute information about the trial version of a product and guide to the trial version” is set. For the customer in Stage 4, “Measure 4: Notify a sales person in charge as a hot lead and direct to purchase” is set.

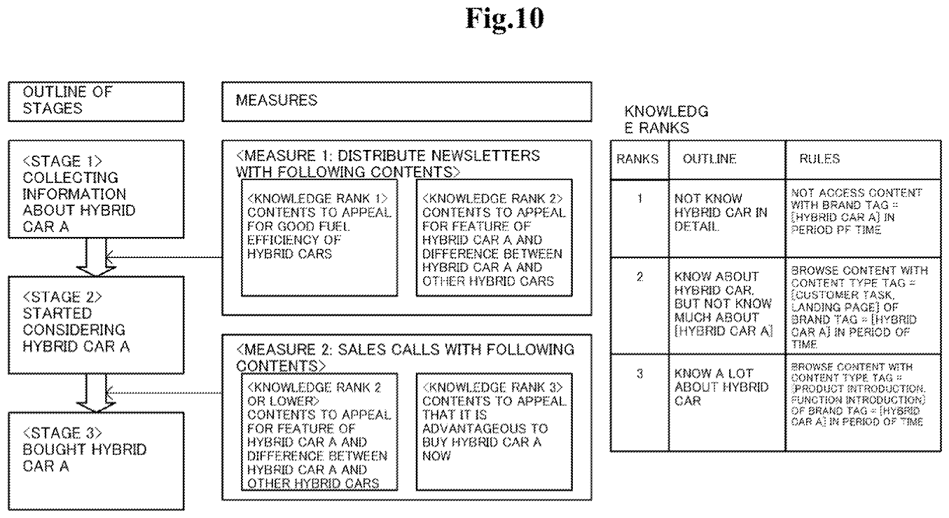

As the measures in the scenario information, those that have different contents in accordance with the rank (degree of involvement) in the bond (involvement item) of a target customer in each stage may be set. For example, in the example of FIG. 10, first, three stages are set. “Measure 1: distribution of newsletters” is set for a customer in Stage 1, and “telecall” is set for a customer in Stage 2. At the time, “Measure 1” set for the customer in Stage 1 has contents of a newsletter appropriate for the knowledge rank of the customer. That is to say, for the customer in “Knowledge rank 1” among the customers in Stage 1, a measure to distribute a newsletter with “contents to appeal for the good fuel efficiency of hybrid cars”. For the customer in “Knowledge rank 2” among the customers in Stage 1, a measure to distribute a newsletter with “contents to appeal for the features of a hybrid car A and the difference between the hybrid car A and other hybrid cars”. Likewise, for the customers in Stage 2, measures appropriate for “the knowledge rank” of the customers are set. The scenario information shown in FIGS. 7 to 10 is an example, and the scenario information is not limited to the contents thereof.

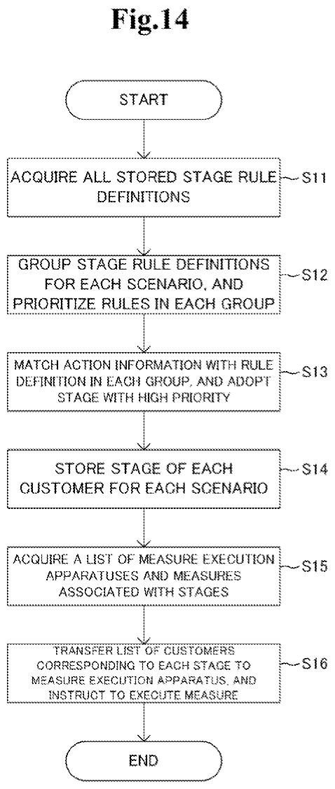

Then, the determining unit 12 determines the stage of a customer by using the stage rule definition information included by the scenario information as described above and the action information of the customer. Specifically, the determining unit 12 first acquires all the stage rule definition information within all the scenario information (step S11 in FIG. 14). Then, the determining unit 12 groups the stage rule definition information for each scenario, and prioritizes the stage rule definition information in each group (step S12 in FIG. 14). For example, the determining unit 12 puts the stage rule definition information related to a “scenario to enhance the bond to Brand A” together as one group, and sets a higher priority to a rule with the stage 2 than a rule with the stage 1.

Subsequently, the determining unit 12 retrieves the action information of the customer, matches the action information of the customer with the stage rule definition information in each group, and adopts a rule with a higher priority (step S13 in FIG. 14). The determining unit 12 determines the stage of the customer in each scenario based on the adopted rule. For example, the determining unit 12 matches the rules “Stage 1” and “Stage 2” with a customer “Nichiden Taro” in a group of a “scenario to enhance the bond to Brand A” and, in a case where the customer matches both the rules “Stage 1” and “Stage 2”, adopts “Stage 2” with a higher priority. Consequently, the determining unit 12 can determine that the customer “Nichiden Taro” is in “Stage 2” in the “scenario to enhance the bond to Brand A”. Then, the determining unit 12 stores the stage of each customer as customer information falling into each stage of the scenario information (step S14 in FIG. 14).

The measure unit 13 (providing unit) provides the customer with a measure corresponding to the stage of the customer determined as described above. In this example embodiment, by instructing a measure execution apparatus 30, the measure unit 13 provides a customer with a measure in cooperation with the measure execution apparatus 30.

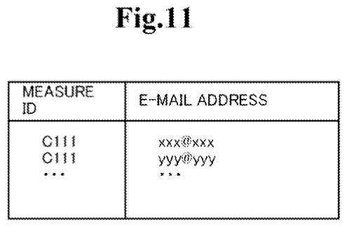

Specifically, the measure unit 13 first acquires a measure corresponding to each stage with reference to the scenario information (step S15 in FIG. 14). Each stage is associated with a corresponding measure and a measure execution apparatus 30 appropriate for executing the measure. Then, the measure unit 13 acquires a list of customer information falling into each stage, transfers the list of customer information to the measure execution apparatus 30 associated with the stage, and instructs the measure execution apparatus 30 to execute a measure corresponding to the stage (step S16 in FIG. 14). For example, the measure unit 13 transfers a measure ID that identifies a measure and an e-mail address of a customer to be provided with the measure to the measure execution apparatus 30 in the form of the list of customer information as shown in FIG. 11.

In a case where measures in scenario information are set in association with bond ranks of customers as shown in FIG. 10, even if customers are in the same stage, the measure unit 13 instructs the measure execution apparatus 30 that executes measures associated with the bond ranks of the customers, respectively. For example, in the case of the measure 1 in the scenario information shown in FIG. 10, the measure unit 13 instructs the measure execution apparatus 30 that performs newsletter distribution to distribute newsletters of different contents to the customer in the stage 1 with the knowledge rank 1 and the customer in the sage 1 with the knowledge rank 2.

Further, even if customers are in the same stage, the measure unit 13 may instruct the measure execution apparatus 30 not to execute a measure on some of the customers and to execute the measure to the other customers excluding the above customers. For example, in a case where the measure is newsletter distribution, the measure unit 13 may not distribute a newsletter to some of the customers in the same stage but distribute the newsletter to the other customers.

After execution of a measure on a customer by the measure unit 13 and the measure execution apparatus 30 as described above, the determining unit 12 (detecting unit, determining unit) of the information processing apparatus 10 determines the stage of the customer after the execution, and examines a change of the stages before and after execution of the measure. That is to say, the determining unit 12 acquires the action information of the customer after execution of the measure on the customer via the acquiring unit 11, and determines the stage of the customer after execution of the measure from the action information in the same manner as described above. Then, by comparing the stage to which the customer belongs before execution of the measure with the stage to which the customer belongs after execution of the measure, the determining unit 12 can measure and evaluate an effect of the measure. The action information of the customer after execution of the measure is acquired, for example, by the acquiring unit 11 from the measure execution apparatus 30 or from the information collection apparatus 20. At the time, the acquiring unit 11 assigns a tag to the action information and stores in the same manner as described above.

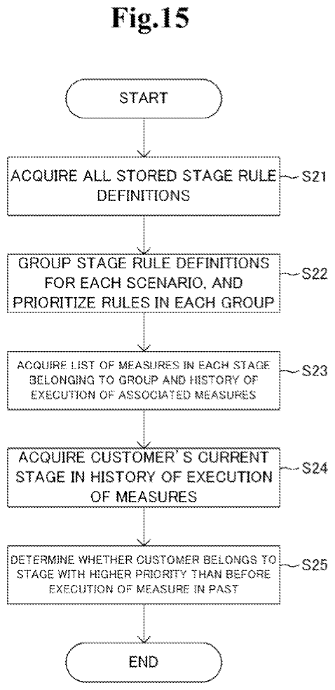

A series of processing operation related to the measurement and evaluation of an effect of a measure will be specifically described using FIG. 15.

The determining unit 12 first acquires all the stage rule definition information in the scenario information in the same manner as described above (step S21 in FIG. 15).

Then, the determining unit 12 groups the stage rule definition information for each scenario, and prioritizes the stage rule definition information in each group (step S22 in FIG. 15). Subsequently, the determining unit 12 acquires a list of measures in each stage and a history of execution of the corresponding measures (step S23 in FIG. 15).

Then, the determining unit 12 determines the stage of the customer after execution of the measure based on the stage rule definition information from the history of execution of the measures (step S24 in FIG. 15).

Furthermore, the determining unit 12 compares the stage of the customer before execution of the measure with the stage of the customer after execution of the measure.

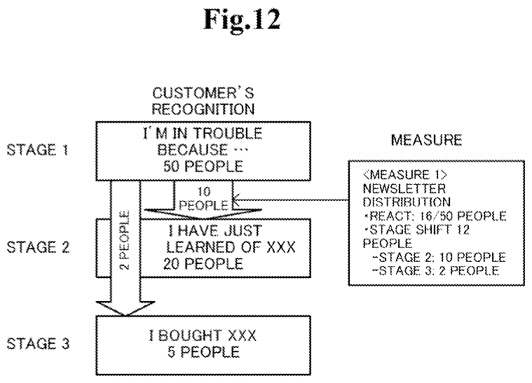

The determining unit 12 determines the presence or absence of a change of the stages before and after execution of the measure based on the result of comparison. Specifically, the determining unit 12 determines whether the priority of the stage after execution of the measure is higher than the priority of the stage before execution of the measure (step S25 in FIG. 15). As an example, it is assumed as shown in FIG. 12 that, after execution of the measure 1 corresponding to the stage 1 on fifty customers in the stage 1, ten customers shifted to the stage 2 and two customers shifted to the stage 3, that is, a total of twelve customers shifted to higher stages. In this case, the output unit 14 may illustrate and output the determination result, that is, information based on the change of the stages before and after execution of the measure as shown in FIG. 12.

Further, the determining unit 12 determines the presence or absence of a change of the bond ranks before and after execution of a measure on a customer. That is to say, the determining unit 12 acquires the action information of the customer after execution of the measure on the customer via the acquiring unit 11, and determines each bond rank of the customer after execution of the measure in the same manner as described above from the action information. At the time, the determining unit 12 determines whether or not the bond ranks of the customers who the measure has not been executed on have also changed between before and after execution of the measure on the other customers. The action information of the customer after execution of the measure is acquired, for example, by the acquiring unit 11 from the measure execution apparatus 30 or from the information collection apparatus 20. At the time, the acquiring unit 11 assigns a tag to the action information and stores in the same manner as described above.

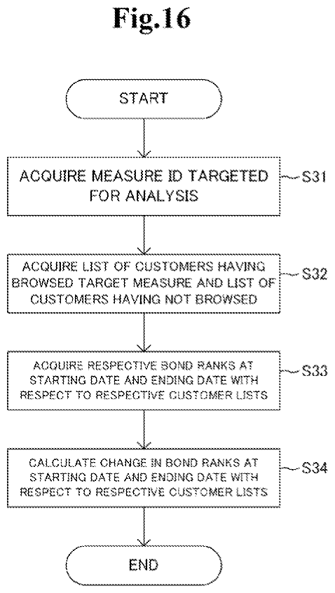

A series of processing operation for determining a change in the ranks between before and after execution of a measure will be specifically described using FIG. 16.

The determining unit 12 acquires the measure ID of an executed measure for each stage (step S31 in FIG. 16). Then, based on the acquired measure ID, the determining unit 12 acquires a history of execution of the associated measure, and extracts a list of customers (other customers) who viewed the measure during a target period when the measure was executed (specify the starting time and date and the ending time and date of the measure), that is, who the measure was executed on. Furthermore, the determining unit 12 compares with the whole customer information, and acquires a list of customers (some customers) who did not browse the measure (step S32 in FIG. 16).

Subsequently, the determining unit 12 determines the bond ranks of the customer after execution of the measure from the action information of the customers who viewed the measure (reacted the measure) and the customers who did not browse (react) after execution of the measure. Then, the determining unit 12 acquires the ranks of the respective bonds at the starting time and date of the measure (before execution of the measure) and the ranks of the respective bonds at the ending time and date of the measure, and compares the ranks (step S33 in FIG. 16). For example, using Equation 1 below, separately for the customers who the measure was executed on and for the customers who the measure was not executed on, the determining unit 12 calculates, for each bond, a change of the rank average values before and after execution of the measure (step S34 in FIG. 16). Moreover, the determining unit 12 compares a change in the rank of the customer who the measure was executed on with a change in the rank of the customer who the measure was not executed on, and calculates the difference using Equation 2. A value calculated by the determining unit 12 is not limited to a change in the average value of the ranks.

$$Δ score = \frac{1}{n} {\sum }_{i = 1}^{n} {end\_score}_{i} - \frac{1}{n} {\sum }_{i = 1}^{n} {start\_score}_{i} \qquad [ Equation 1 ]$$

end_scoreᵢ: bond rank at the ending time and date of customer i
start_scoreᵢ: bond rank at the starting time and date of customer i

ΔΔscore=Δscore_{treated}−Δscore_{untreated} [Equation 2]

Δscore_{treated}: change in bond rank of customer who viewed the measure
Δscore_{untreated}: change in bond rank of customer who did not browse the measure

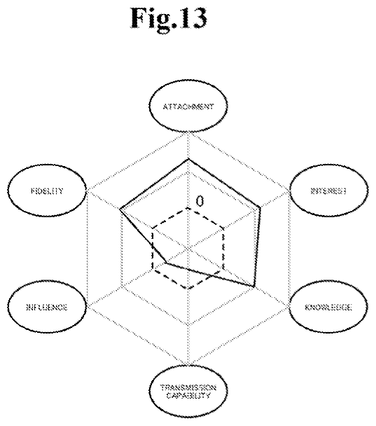

The output unit 14 (detecting unit, determining unit) outputs information based on the results of calculation by the determining unit 12 using Equation 1 and Equation 2. For example, the output unit 14 outputs, for each bond, a numerical value representing the change in the average rank values or the like before and after execution of the measure, or outputs a numerical value representing the difference between the change in the rank of the customer who the measure was executed on and the change in the rank of the customer who the measure was not executed on. At the time, as shown in FIG. 13, the output unit 14 may display, on a graph with six bonds set as axes, the difference between the change in the rank of the customer who the measure was executed on and the change in the rank of the customer who the measure was not executed on, that is, information about a change in the customer's rank in accordance with the presence/absence of execution of the measure. In FIG. 13, the difference 0 is indicated by dotted line, and a calculated difference value is indicated by solid line. By thus displaying and outputting the graph, it is possible to easily recognize an effect of execution of the measure on each bond.

Thus, since the information processing apparatus 10 described above executes a measure appropriate for the stage of a customer, and calculates changes in the stage (degree of recognition) and the bond rank (degree of involvement) of the customer after execution of the measure, a company having executed the measure can recognize an effect of the measure. Therefore, the information processing apparatus 10 can provide the company with appropriate and prompt marketing assistance.

### Third Example Embodiment

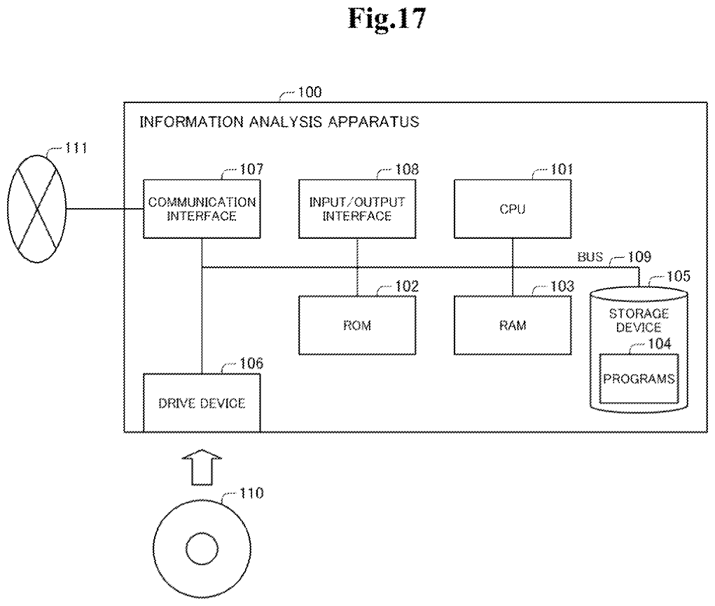

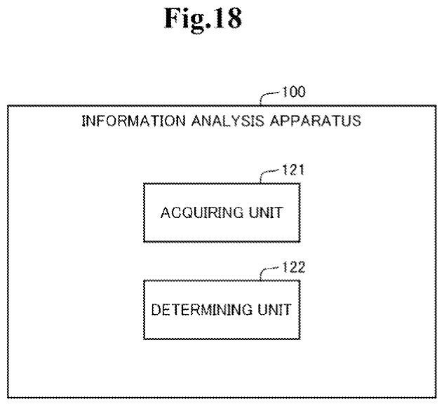

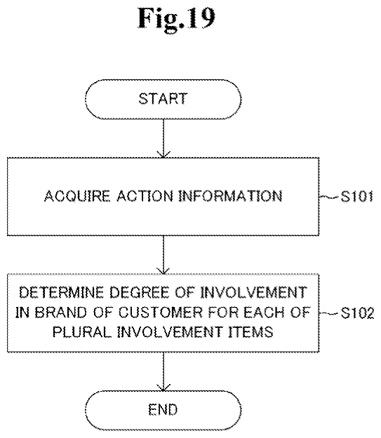

Next, a third example embodiment of the present invention will be described with reference to FIGS. 17 to 19. FIGS. 17 to 18 are block diagrams showing a configuration of an information analysis apparatus in the third example embodiment, and FIG. 19 is a flowchart showing an operation of the information analysis apparatus. In this example embodiment, the overview of the configurations of the information analysis apparatus and the information analysis method described in the above example embodiments is shown.

First, with reference to FIG. 17, a hardware configuration of an information analysis apparatus 100 in this example embodiment will be described. The information analysis apparatus 100 is configured by a general-purpose information processing apparatus and, as an example, has a hardware configuration as shown below including;

a CPU (Central Processing Unit) 101 (arithmetic logic unit),

a ROM (Read Only Memory) 102 (memory unit),

a RAM (Random Access Memory) 103 (memory unit),

programs 104 loaded to the RAM 103,

a storage device 105 for storing the programs 104,

a drive device 106 that reads from and writes into a storage medium 110 outside the information processing apparatus,

a communication interface 107 connected to a communication network 111 outside the information processing apparatus, an input/output interface 108 performing input/output of data, and a bus 109 connecting the respective components.

Then, by acquisition and execution of the programs 104 by the CPU 101, the information analysis apparatus 100 can structure and include an acquiring unit 121 and a determining unit 122 shown in FIG. 18. The programs 104 are, for example, stored in the storage device 105 and the ROM 102 in advance, and loaded to the RAM 103 and executed by the CPU 101 as necessary. Moreover, the programs 104 may be supplied to the CPU 101 via the communication network 111, or may be stored in the storage medium 110 in advance and retrieved by the drive device 106 and supplied to the CPU 101. Meanwhile, the acquiring unit 121 and the determining unit 122 mentioned above may be structured by an electronic circuit dedicated for implementation of these units.

FIG. 17 shows an example of the hardware configuration of the information processing apparatus serving as the information analysis apparatus 100, and the hardware configuration of the information processing apparatus is not limited to the above case. For example, the information processing apparatus may include part of the above configuration, such as excluding the drive device 106.

Then, the information analysis apparatus 100 executes an information analysis method shown in the flowchart of FIG. 19 by the functions of the acquiring unit 121 and the determining unit 122 structured by the programs as described above.

As shown in FIG. 19, the information analysis apparatus 100 executes processes to: acquire action information representing an action of a customer (step S101); and based on the action information, for each of a plurality of kinds of involvement items set for a predetermined brand, determine a degree of involvement in the brand of the customer (step S102).

With the configurations as described above, the present invention enables measurement of the degrees of a plurality of involvement items such as knowledge and fidelity with respect to a brand of a customer, and measurement of the loyalty to the brand of the customer from various perspectives. As a result, the company can analyze the customer's loyalty in detail and further increase marketing activities by taking measures such as a measure appropriate for the analysis result.

The abovementioned program can be stored using various types of non-transitory computer-readable mediums and supplied to a computer. The non-transitory computer-readable mediums include various types of tangible storage mediums. Examples of the non-transitory computer-readable mediums include a magnetic recording medium (for example, a flexible disk, a magnetic tape, a hard disk drive), a magneto-optical recording medium (for example, a magneto-optical disk), a CD-ROM (Read Only Memory), a CD-R, a CD-R/W, and a semiconductor memory (for example, a mask ROM, a PROM (Programmable ROM), an EPROM (Erasable PROM), a flash ROM, a RAM (Random Access Memory)). Moreover, the program may be supplied to a computer by various types of transitory computer-readable mediums. Examples of the transitory computer-readable mediums include an electric signal, an optical signal, and an electromagnetic wave. The transitory computer-readable medium can supply the program to a computer via a wired communication path such as an electric wire and an optical fiber or via a wireless communication path.

Although the present invention has been described above with reference to the example embodiments, the present invention is not limited to the example embodiments. The configurations and details of the present invention can be changed in various manners that can be understood by one skilled in the art within the scope of the present invention. Moreover, at least one or more functions of the functions of the acquiring unit 121 and the determining unit 122 described above may be executed by an information processing apparatus installed in any place on a network and connected, that is, may be executed by so-called cloud computing.

### Supplementary Notes

The whole or part of the example embodiments disclosed above can be described as the following supplementary notes. Below, the overview of configurations of an information analysis method, an information analysis apparatus and a program according to the present invention will be described. However, the present invention is not limited to the following configurations.

### Supplementary Note 1

An information analysis method comprising:

acquiring action information representing an action of a customer; and

determining, for each of a plurality of kinds of involvement items set for a predetermined brand, a degree of involvement in the brand of the customer based on the action information.

### Supplementary Note 2

The information analysis method according to Supplementary Note 1, comprising:

acquiring the action information having content set for each of the involvement items; and

determining, for each of the involvement items, the degree of involvement of the customer based on the content of the action information set for each of the involvement items.

### Supplementary Note 3

The information analysis method according to Supplementary Note 2, comprising

determining, for each of the involvement items, the degree of involvement of the customer based on a preset degree of the action of the customer based on the action information having the content set for each of the involvement items.

### Supplementary Note 4

The information analysis method according to Supplementary Note 3, comprising

determining so that, as the preset degree of the action of the customer based on the action information having the content set for each of the involvement items is higher in accordance with a preset criterion, the degree of involvement of the customer becomes higher for the corresponding involvement item.

### Supplementary Note 5

The information analysis method according to Supplementary Note 3 or 4, comprising

based on a degree of participation action of the customer in an executed measure on the brand, which is the content of the action information set for one of the involvement items, determining the degree of involvement of the customer for the corresponding involvement item.

### Supplementary Note 6

The information analysis method according to any of Supplementary Notes 3 to 5, comprising

based on a degree of action relating to purchase of a product relating to the brand, which is the content of the action information set for one of the involvement items, determining the degree of involvement of the customer for the corresponding involvement item.

### Supplementary Note 7

The information analysis method according to any of Supplementary Notes 3 to 6, comprising

based on a degree of action relating to reception or transmission of information relating to the brand, which is the content of the action information set for one of the involvement items, determining the degree of involvement of the customer for the corresponding involvement item.

### Supplementary Note 8

The information analysis method according to any of Supplementary Notes 1 to 7, wherein the action information includes the brand targeted for the action of the customer, the information analysis method comprising

determining, for each brand, the degree of involvement of the customer for each of the involvement items based on the action information.

### Supplementary Note 9

The information analysis method according to any of Supplementary Notes 1 to 8, comprising:

providing the customer with a measure to be executed on the customer from a scenario in which the measure is set; and

determining the degree of involvement of the customer based on the action information of the customer after provision of the measure.

### Supplementary Note 10

The information analysis method according to Supplementary Note 9, comprising

determining the degree of involvement of the customer before provision of the measure and the degree of involvement of the customer after provision of the measure based on the action information of the customer before provision of the measure and the action information of the customer after provision of the measure.

### Supplementary Note 11

The information analysis method according to Supplementary Note 9 or 10, wherein the measures that vary with the degrees of involvement of the customer are set in the scenario, the information analysis method comprising

providing the customer with the measure corresponding to the degree of involvement of the customer.

### Supplementary Note 12

An information analysis apparatus comprising:

an acquiring unit configured to acquire action information representing an action of a customer; and

a determining unit configured to determine, for each of a plurality of kinds of involvement items set for a predetermined brand, a degree of involvement in the brand of the customer based on the action information.

### Supplementary Note 13

The information analysis apparatus according to Supplementary Note 12, wherein:

the acquiring unit is configured to acquire the action information having content set for each of the involvement items; and

the determining unit is configured to determine, for each of the involvement items, the degree of involvement of the customer based on the content of the action information set for each of the involvement items.

### Supplementary Note 14

The information analysis apparatus according to Supplementary Note 13, wherein

the determining unit is configured to determine, for each of the involvement items, the degree of involvement of the customer based on a preset degree of the action of the customer based on the action information having the content set for each of the involvement items.

### Supplementary Note 15

The information analysis apparatus according to Supplementary Note 14, wherein

the determining unit is configured to determine so that, as the preset degree of the action of the customer based on the action information having the content set for each of the involvement items is higher in accordance with a preset criterion, the degree of involvement of the customer becomes higher for the corresponding involvement item.

### Supplementary Note 16

The information analysis apparatus according to Supplementary Note 14 or 15, wherein

the determining unit is configured to, based on a degree of participation action of the customer in an executed measure on the brand, which is the content of the action information set for one of the involvement items, determine the degree of involvement of the customer for the corresponding involvement item.

### Supplementary Note 17

The information analysis apparatus according to any of Supplementary Notes 14 to 16, wherein

the determining unit is configured to, based on a degree of action relating to purchase of a product relating to the brand, which is the content of the action information set for one of the involvement items, determine the degree of involvement of the customer for the corresponding involvement item.

### Supplementary Note 18

The information analysis apparatus according to any of Supplementary Notes 14 to 17, wherein

the determining unit is configured to, based on a degree of action relating to reception or transmission of information relating to the brand, which is the content of the action information set for one of the involvement items, determine the degree of involvement of the customer for the corresponding involvement item.

### Supplementary Note 19

The information analysis apparatus according to any of Supplementary Notes 12 to 18, wherein:

the action information includes the brand targeted for the action of the customer; and

the determining unit is configured to determine, for each brand, the degree of involvement of the customer for each of the involvement items based on the action information.

### Supplementary Note 20

The information analysis method according to any of Supplementary Notes 12 to 19, comprising

a providing unit configured to provide the customer with a measure to be executed on the customer from a scenario in which the measure is set, wherein

the determining unit is configured to determine the degree of involvement of the customer based on the action information of the customer after provision of the measure.

### Supplementary Note 21

The information analysis apparatus according to Supplementary Note 20, wherein

the determining unit is configured to determine the degree of involvement of the customer before provision of the measure and the degree of involvement of the customer after provision of the measure, based on the action information of the customer before provision of the measure and the action information of the customer after provision of the measure.

### Supplementary Note 22

The information analysis apparatus according to Supplementary Note 20 or 21, wherein:

the measures that vary with the degrees of involvement of the customer are set in the scenario; and

the providing unit is configured to provide the customer with the measure corresponding to the degree of involvement of the customer.

### Supplementary Note 23

A non-transitory computer-readable medium having a computer program stored therein, the computer program comprising instructions to cause an information processing apparatus to implement:

an acquiring unit configured to acquire action information representing an action of a customer; and

a determining unit configured to determine, for each of a plurality of kinds of involvement items set for a predetermined brand, a degree of involvement in the brand of the customer based on the action information.

### Supplementary Note A1

An information analysis method comprising:

acquiring a scenario in which measures to be executed on a customer corresponding to respective degrees of recognition of the customer for a predetermined brand;

providing the customer with the measure corresponding to the degree of recognition of the customer among the measures set in the scenario; and

detecting the degree of recognition of the customer based on action information representing action of the customer after provision of the measure.

### Supplementary Note A2

The information analysis method according to Supplementary Note A1, comprising outputting information relating to a change in the degree of recognition of the customer based on a result of comparison between the degree of recognition of the customer before provision of the measure and the degree of recognition of the customer after provision of the measure.

### Supplementary Note A3

The information analysis method according to Supplementary Note A1 or A2, comprising

determining a degree of involvement in the brand of the customer for an involvement item set for the brand before provision of the measure and after provision of the measure based on the action information of the customer before provision of the measure and the action information of the customer after provision of the measure.

### Supplementary Note A4

The information analysis method according to Supplementary Note A3, comprising

outputting information relating to a change in the degree of involvement of the customer based on a result of comparison between the degree of involvement of the customer before provision of the measure and the degree of involvement of the customer after provision of the measure.

### Supplementary Note A5

The information analysis method according to Supplementary Note A3 or A4, comprising:

providing other customer excluding a certain customer with the measure; and

before providing the other customer with the measure and after providing the other customer with the measure, determining the degree of involvement of the certain customer based on the action information of the certain customer, and also determining the degree of involvement of the other customer based on the action information of the other customer.

### Supplementary Note A6

The information analysis method according to Supplementary Note A5, comprising

outputting information relating to a change in the degree of involvement of the other customer based on a result of comparison between the degree of involvement of the other customer before provision of the measure and the degree of involvement of the other customer after provision of the measure.

### Supplementary Note A7

The information analysis method according to Supplementary Note A6, comprising

comparing the degree of involvement of the certain customer before providing the other customer with the measure with the degree of involvement of the certain customer after providing the other customer with the measure, comparing a result of comparison of the degrees of involvement of the certain customer with a result of comparison of the degrees of involvement of the other customer, and outputting information based on the comparison result.

### Supplementary Note A8

The information analysis method according to any of Supplementary Notes A3 to A7, comprising

determining, for each of a plurality of kinds of involvement items set for the brand, the degrees of involvement in the brand of the customer before provision of the measure and after provision of the measure based on the action information of the customer before provision of the measure and after provision of the measure.

### Supplementary Note A9

The information analysis method according to any of Supplementary Notes A3 to A8, comprising:

acquiring the scenario in which, for each of the degrees of recognition of the customer, the measures varying with the degrees of involvement of the customer are set; and

providing the customer with the measure corresponding to the degree of recognition and the degree of involvement of the customer.

### Supplementary Note A10

An information analysis apparatus comprising:

a providing unit configured to acquire a scenario in which measures to be executed on a customer corresponding to respective degrees of recognition of the customer for a predetermined brand, and provide the customer with the measure corresponding to the degree of recognition of the customer among the measures set in the scenario; and

a detecting unit configured to detect the degree of recognition of the customer based on action information representing action of the customer after provision of the measure.

### Supplementary Note A11

The information analysis apparatus according to Supplementary Note A11, wherein

the detecting unit is configured to output information relating to a change in the degree of recognition of the customer based on a result of comparison between the degree of recognition of the customer before provision of the measure and the degree of recognition of the customer afterprovision of the measure.

### Supplementary Note A12

The information analysis apparatus according to Supplementary Note A10 or A11, comprising

a determining unit configured to determine a degree of involvement in the brand of the customer for an involvement item set for the brand before provision of the measure and after provision of the measure based on the action information of the customer before provision of the measure and the action information of the customer after provision of the measure.

### Supplementary Note A13

The information analysis apparatus according to Supplementary Note A12, wherein

the determining unit is configured to output information relating to a change in the degree of involvement of the customer based on a result of comparison between the degree of involvement of the customer before provision of the measure and the degree of involvement of the customer after provision of the measure.

### Supplementary Note A14

The information analysis apparatus according to Supplementary Note A12 or A13, wherein:

the providing unit is configured to provide other customer excluding a certain customer with the measure; and

the determining unit is configured to, before providing the other customer with the measure and after providing the other customer with the measure, determine the degree of involvement of the certain customer based on a content of the action information of the certain customer, and also determine the degree of involvement of the other customer based on a content of the action information of the other customer.

### Supplementary Note A15

The information analysis apparatus according to Supplementary Note A14, wherein

the determining unit is configured to output information relating to a change in the degree of involvement of the other customer based on a result of comparison between the degree of involvement of the other customer before provision of the measure and the degree of involvement of the other customer after provision of the measure.

### Supplementary Note A16

The information analysis apparatus according to Supplementary Note A15, wherein

the determining unit is configured to compare the degree of involvement of the certain customer before providing the other customer with the measure with the degree of involvement of the certain customer after providing the other customer with the measure, compare a result of comparison of the degrees of involvement of the certain customer with a result of comparison of the degrees of involvement of the other customer, and output information based on the comparison result.

### Supplementary Note A17

The information analysis apparatus according to any of Supplementary Notes A12 to A16, wherein

the determining unit is configured to determine, for each of a plurality of kinds of involvement items set for the brand, the degrees of involvement in the brand of the customer before provision of the measure and after provision of the measure based on the action information of the customer before provision of the measure and after provision of the measure.

### Supplementary Note A18

The information analysis apparatus according to any of Supplementary Notes A12 to A17, wherein

the providing unit is configured to acquire the scenario in which, for each of the degrees of recognition of the customer, the measures varying with the degrees of involvement of the customer are set, and provide the customer with the measure corresponding to the degree of recognition and the degree of involvement of the customer.

### Supplementary Note A19

A non-transitory computer-readable medium having a computer program stored therein, the computer program comprising instructions to cause an information processing apparatus to implement:

a providing unit configured to acquire a scenario in which measures to be executed on a customer corresponding to respective degrees of recognition of the customer for a predetermined brand, and provide the customer with the measure corresponding to the degree of recognition of the customer among the measures set in the scenario; and

a detecting unit configured to detect the degree of recognition of the customer based on action information representing action of the customer after provision of the measure.

### Supplementary Note A20

The non-transitory computer-readable medium having the computer program stored therein according to Supplementary Note A19, the computer program comprising instructions to cause the information processing apparatus to further implement

determining unit configured to determine a degree of involvement in the brand of the customer for an involvement item set for the brand before provision of the measure and after provision of the measure based on the action information of the customer before provision of the measure and the action information of the customer after provision of the measure.

### DESCRIPTION OF NUMERALS

10 information processing apparatus

11 acquiring unit

12 determining unit

13 measure unit

14 output unit

16 action information storing unit

17 rank definition storing unit

18 scenario information storing unit

19 user information storing unit

20 information collection apparatus

30 measure execution apparatus

100 information analysis apparatus

101 CPU

102 ROM

103 RAM

104 programs

105 storage device

106 drive device

107 communication interface

108 input/output interface

109 bus

110 storage medium

111 communication network

121 acquiring unit

122 determining unit

What is claimed is:

1. An information analysis method comprising:
acquiring action information representing an action of a customer; and
determining, for each of a plurality of kinds of involvement items set for a predetermined brand, a degree of involvement in the brand of the customer based on the action information.

2. The information analysis method according to claim 1, comprising:
acquiring the action information having content set for each of the involvement items; and
determining, for each of the involvement items, the degree of involvement of the customer based on the content of the action information set for each of the involvement items.

3. The information analysis method according to claim 2, comprising
determining, for each of the involvement items, the degree of involvement of the customer based on a preset degree of the action of the customer based on the action information having the content set for each of the involvement items.

4. The information analysis method according to claim 3, comprising
determining so that, as the preset degree of the action of the customer based on the action information having the content set for each of the involvement items is higher in accordance with a preset criterion, the degree of involvement of the customer becomes higher for the corresponding involvement item.

5. The information analysis method according to claim 3, comprising
based on a degree of participation action of the customer in an executed measure on the brand, which is the content of the action information set for one of the involvement items, determining the degree of involvement of the customer for the corresponding involvement item.

6. The information analysis method according to claim 3, comprising
based on a degree of action relating to purchase of a product relating to the brand, which is the content of the action information set for one of the involvement items, determining the degree of involvement of the customer for the corresponding involvement item.

7. The information analysis method according to claim 3, comprising
based on a degree of action relating to reception or transmission of information relating to the brand, which is the content of the action information set for one of the involvement items, determining the degree of involvement of the customer for the corresponding involvement item.

8. The information analysis method according to claim 1, wherein the action information includes the brand targeted for the action of the customer, the information analysis method comprising
determining, for each brand, the degree of involvement of the customer for each of the involvement items based on the action information.

9. The information analysis method according to claim 1, comprising:
providing the customer with a measure to be executed on the customer from a scenario in which the measure is set; and
determining the degree of involvement of the customer based on the action information of the customer after provision of the measure.

10. The information analysis method according to claim 9, comprising
determining the degree of involvement of the customer before provision of the measure and the degree of involvement of the customer after provision of the measure, based on the action information of the customer before provision of the measure and the action information of the customer after provision of the measure.

11. The infomation analysis method according to claim 9, wherein the measures that vary with the degrees of involvement of the customer are set in the scenario, the information analysis method comprising
providing the customer with the measure corresponding to the degree of involvement of the customer.

12. An information analysis apparatus comprising:
at least one memory configured to store instructions; and
at least one processor configured to execute the instructions to:
acquire action information representing an action of a customer; and
determine, for each of a plurality of kinds of involvement items set for a predetermined brand, a degree of involvement in the brand of the customer based on the action information.

13. The information analysis apparatus according to claim 12, wherein the at least one processor is configured to execute the instructions to:
acquire the action information having content set for each of the involvement items; and
determine, for each of the involvement items, the degree of involvement of the customer based on the content of the action information set for each of the involvement items.

14. The information analysis apparatus according to claim 13, wherein the at least one processor is configured to execute the instructions to
determine, for each of the involvement items, the degree of involvement of the customer based on a preset degree of the action of the customer based on the action information having the content set for each of the involvement items.

15. The information analysis apparatus according to claim 14, wherein the at least one processor is configured to execute the instructions to
determine so that, as the preset degree of the action of the customer based on the action information having the content set for each of the involvement items is higher in accordance with a preset criterion, the degree of involvement of the customer becomes higher for the corresponding involvement item.

16. The information analysis apparatus according to claim 14, wherein the at least one processor is configured to execute the instructions to
based on a degree of participation action of the customer in an executed measure on the brand, which is the content of the action information set for one of the involvement items, determine the degree of involvement of the customer for the corresponding involvement item.

17. The information analysis apparatus according to claim 14, wherein the at least one processor is configured to execute the instructions to
based on a degree of action relating to purchase of a product relating to the brand, which is the content of the action information set for one of the involvement items, determine the degree of involvement of the customer for the corresponding involvement item.

18. The information analysis apparatus according to claim 14, wherein the at least one processor is configured to execute the instructions to
based on a degree of action relating to reception or transmission of information relating to the brand, which is the content of the action information set for one of the involvement items, determine the degree of involvement of the customer for the corresponding involvement item.

19. (canceled)

20. The information analysis method according to comprising claim 12, wherein the at least one processor is configured to execute the instructions to:
provide the customer with a measure to be executed on the customer from a scenario in which the measure is set, wherein
determine the degree of involvement of the customer based on the action information of the customer after provision of the measure.

21. (canceled)

23. A non-transitory computer-readable mcdium having a computer program stored therein, the computer program comprising instructions to cause an information processing apparatus to execute processes to:
acquire action information representing an action of a customer; and
determine, for each of a plurality of kinds of involvement items set for a predetermined brand, a degree of involvement in the brand of the customer based on the action information.
